(19) United States
(12) Patent Application Publication
(10) Pub. No.: US 2012/0226420 A1
(43) Pub. Date: Sep. 6, 2012

(54) VEHICLE, IN PARTICULAR INDUSTRIAL TRUCK

(75) Inventors: Wolfgang BAUER, Moosburg (DE); Peter JAKUBIK, Landshut (DE); Bernhard KUBA, Zolling (DE)

(73) Assignee: JUNGHEINRICH AKTIENGESELLSCHAFT, Hamburg (DE)

(21) Appl. No.: 13/409,609

(22) Filed: Mar. 1, 2012

(30) Foreign Application Priority Data
Mar. 2, 2011 (DE) 10 2011 004 995.9

(51) Int. Cl. B66F 9/075; G06F 11/30; G01M 17/00

(52) U.S. Cl. 701/50

(57) ABSTRACT

The invention relates to a vehicle, in particular an industrial truck, with a drive motor for the traction drive, a brake system and a driving state monitoring device that comprises an electronic control device and at least one driving movement sensor responding to a traction movement of the vehicle and relaying driving movement information to the electronic control device, wherein the driving state monitoring device is designed to carry out a brake function check when the vehicle is started, wherein when the brake system is activated to brake the vehicle the monitoring device activates the drive motor.

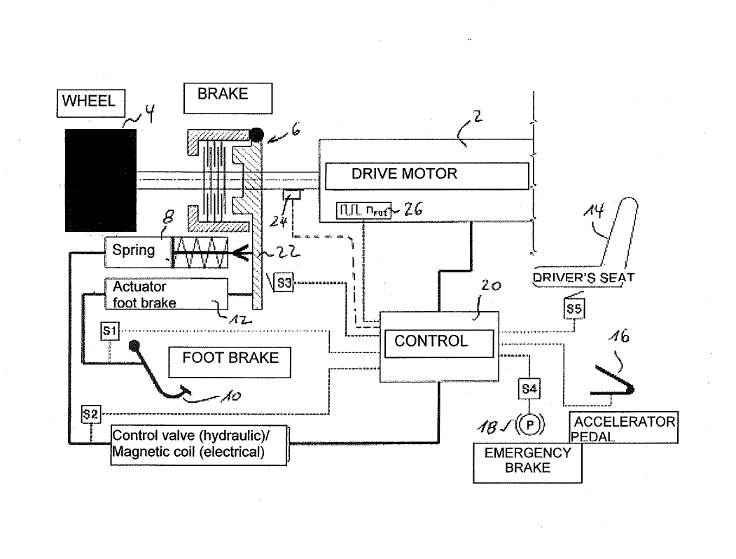

The present invention relates to a vehicle, in particular an industrial truck, with a drive motor (prime mover) for the traction drive, a brake system and a driving state monitoring device that comprises an electronic control device and at least one driving movement sensor responding to traction movement of the vehicle and relaying driving movement information to the electronic control unit.

The present invention is preferably employed in electrically driven industrial trucks, in particular in so-called electric fork-lift trucks.

In principle it is the task and responsibility of the driver of such a vehicle to check its operational safety and in particular the operation of the brakes at regular intervals, in which connection the brake check should be carried out every time the vehicle is started. If such a brake function check is forgotten or is omitted due to negligence, there is the danger that the vehicle will be driven with defective or worn brakes. As a result the safety of the driver of the vehicle and any persons in the vicinity of the vehicle may be seriously jeopardised.

The object of the present invention is to improve the operational safety of a vehicle of the type mentioned in the introduction.

To achieve this object it is proposed according to the invention that in a vehicle with the features mentioned in the introduction, the driving state monitoring device is designed to carry out a brake function check when the vehicle is started, wherein when the braking system is activated to brake the vehicle the monitoring device activates the drive motor to perform a traction movement of the vehicle during a test time interval, and collects and evaluates driving movement information from the driving movement sensor by means of the electrical control device in order to decide whether an unallowable driving movement takes place despite the brake system having been activated, the driving state monitoring device furthermore being designed to trigger a malfunction response, preferably to prevent the driving operation of the vehicle, if the brake function check reveals an unallowable driving movement of the vehicle in the test time interval.

The brake function check is preferably carried out automatically within a self-test phase immediately after starting the vehicle. It can however also be envisaged that a brake function check takes place before issuing a first driving command after the respective start-up of the vehicle.

If the control device detects an unallowable driving movement of the vehicle during the test time interval of the brake function check, this is interpreted to mean that the brake system is not functioning correctly. The malfunction response then triggered by the driving state monitoring device can be an optical and/or an acoustic alarm. Preferably however a start-up of the vehicle is prevented by the driving state monitoring device. This can take place for example by the driving state monitoring device switching off the vehicle completely. A warning indicating a defective brake system can for example be optically displayed on a display in the vehicle and/or acoustically emitted by a loudspeaker or the like.

Preferably the vehicle is an industrial truck, in which the drive motor is an electric motor, the driving state monitoring device being designed to feed at least one defined electrical drive impulse to the electric motor during the test time interval. The test time interval should be extremely short, so that the vehicle undergoing the brake function check then also cannot execute any significant movement if the brakes are not functioning.

The brake system can include an emergency or hand brake, for example in the form of a self-engaging spring mechanism brake, as well as also an actively operated service or foot brake, wherein the function check by the driving state monitoring device preferably includes a function check of the emergency brake and a function check of the service brake.

The driving movement sensor is preferably a speed sensor and/or a rotational angle sensor in the drive train of the vehicle, which responds even at comparatively small rotational angles.

In the brake function check the driving state monitoring device should also monitor and take into account the brake actuation conditions, for example by monitoring the actuation of a brake pedal of the vehicle or brake actuation signals of an electrical, optical, pneumatic or hydraulic nature, depending on the design of the brake system. Thus, the vehicle can for example also include a driving state monitoring device that is designed to activate the brake system in various brake actuation stages in the brake function test, in order to obtain more precise information on the state of the brake system.

The invention is described in more detail hereinafter with reference to the accompanying FIGURE.

The FIGURE shows in a schematic and partly as a block diagram representation components of an electric fork-lift truck according to the invention. The electric fork-lift truck has an electric motor 2 as drive motor for the traction drive, wherein the electric motor drives drive wheels 4, only one of which is shown in the FIGURE. A brake system 6 serves to brake the vehicle and performs a service brake function as well as an emergency brake function. In the specific example the brakes of the brake system 6 include a spring mechanism 8 that mechanically engages the brake under the force of the spring when the electric fork-lift truck is switched off. After the electric fork-lift truck has been switched on the spring mechanism brake can be electrically or hydraulically activated (depending on the design), in order to release the brake so that the electric fork-lift truck is then ready to drive. A brake pedal 10 and an actuator 12 are provided in order to release the service brake function, which on actuation of the brake pedal 10 activates the brake system so as to brake the fork-lift truck. The driver of the fork-lift truck occupies a driver's seat 14, from which he can reach the accelerator pedal 16 to accelerate the vehicle and the brake pedal 10 with his feet. From the driver's seat 14 the driver can also reach an actuating element 18 of the emergency brake.

The driving state monitoring device of the fork-lift truck comprises an electronic control device 20, to which various sensors are connected and which is designed to control the operation of the drive motor 2 depending on driving commands from the operator, and possibly further parameters. In the particular example the vehicle is started by actuating a starting button and/or actuating a starting unit with an ignition key, so that the control device 20 is connected to the electrical circuit and can operate. A self-test phase first of all takes place, in which various operating functions of the vehicle are checked, including according to the invention also a brake function check. In this connection the control device can determine by means of the sensors S1, S2, S3 and S4 the respective brake actuation state of the brake system 6, namely whether the brake pedal 10 is actuated or the spring mechanism 8 is tensioned so as to release the brake, or the actuating element 18 of the emergency brake is activated or a pressure plate 22 of the brake is in the brake actuation state.

In the brake function check the control device 20 can initiate an activation of the brake 6 or first of all prevent the release of the brake by the spring mechanism 8 and deliver during a short test interval at least one defined brief electrical drive pulse to the electric motor 2, in order to preset a speed or torque target value.

A sensor 24 on the drive train of the fork-lift truck monitors whether the fork-lift truck is moving during the test time interval despite the brake 6 having being actuated, in which connection the sensor 24 relays its speed and/or rotational angle information to the control device 20. If the control device 20 establishes on the basis of the signals from the sensor 24 and/or possibly from an additional speed sensor 26 that a preset limiting speed or a preset rotational angle increment is exceeded in the drive train, then the brake system 6 is classed as defective and a corresponding malfunction reaction is triggered by the control device 20. This can be an optical and/or an acoustic warning. Preferably the malfunction reaction should include the immediate cessation of the driving operation of the vehicle if the brake function check reveals an unallowable driving movement of the fork-lift truck in the test time interval. The cessation of the driving operation is effected in the present example by the fact that the control device 20 provides no electrical drive pulse to the drive motor 2.

The brake function check can be restricted to a brake function, for example to check the reliable working of the spring brake in a combined brake system, as illustrated in the FIGURE. The brake function check however preferably includes the service brake function and possibly also the emergency brake function.

1. Vehicle, in particular an industrial truck, with a drive motor (2) for the traction drive, a brake system (6) and a driving state monitoring device that comprises an electronic control device (20) and at least one driving movement sensor (24, 26) responding to a traction movement of the vehicle and relaying driving movement information to the electronic control device, characterised in that the driving state monitoring device is designed to carry out a brake function check when the vehicle is started, wherein when the brake system (6) is activated to brake the vehicle the monitoring device activates the drive motor (2) to execute a traction movement of the vehicle during a test time interval and collects and evaluates driving movement information from the driving movement sensor (24, 26) by means of the electronic control device (20), in order to decide whether an unallowable driving movement is occurring despite the brake system having been actuated, wherein the driving state monitoring device is furthermore designed to trigger a malfunction response, preferably to stop the driving of the vehicle, if the brake function check reveals an unallowable driving movement of the vehicle in the test time interval.

2. Vehicle according to claim 1, characterised in that the drive motor (2) comprises at least one electric motor, and that the driving state monitoring device is designed to send at least one defined electrical drive pulse to the electric motor (2) during the test time interval.

3. Vehicle according to claim 1, characterised in that the driving state monitoring device is designed to activate the brake system (6) so as to brake the vehicle during the brake function check.

4. Vehicle according to claim 3, characterised in that the driving state monitoring device is designed to activate the brake system (6) in various brake actuation stages during the brake function monitoring.

5. Vehicle according to claim 1, characterised in that the driving movement sensor (24, 26) is a speed sensor and/or a rotational angle sensor.

6. Vehicle according to claim 1, characterised in that the driving state monitoring device comprises at least one sensor (S1, S2, S3, S4) for monitoring the brake actuation state of the brake system (6) and is designed to take into account data supplied by the sensor for the monitoring of the brake actuation state during the brake function check.

7. Vehicle according to claim 1, characterised in that the brake system comprises an emergency brake function and a service brake function and that the brake function check includes a functional check of the emergency brake function and a functional check of the service brake function.
